(19) United States
(12) Patent Application Publication
(10) Pub. No.: US 2023/0410287 A1
(43) Pub. Date: Dec. 21, 2023

(54) Machine Learning Fault Detection in Manufacturing

(71) Applicant: Robert Bosch GmbH, Stuttgart (DE)

(72) Inventors: Michel De la O Frias, San Luis Potosi (MX); Diego Cerino Mata, San Luis Potosi (MX)

(21) Appl. No.: 18/209,809

(22) Filed: Jun. 14, 2023

Related U.S. Application Data
(60) Provisional application No. 63/353,919, filed on Jun. 21, 2022.

(51) Int. Cl. G06T 7/00

(52) U.S. Cl. CPC G06T 7/001; G06T 2207/10016; G06T 2207/10024; G06T 2207/20081

(57) ABSTRACT

A defect detection system and method thereof for automatically detecting visually-observable defects in an article of manufacture after particular stages of the manufacturing process. The defect detection system utilizes a camera having enhanced color and resolution specifications compared to conventional camera-based systems. The system additionally utilizes machine learning from a corpus of training data to build models suitable for defect detection. Additional usage of the system may improve the detection by expanding to the corpus with image data acquired during detection.

### TECHNICAL FIELD

This disclosure relates to an automated manufacturing process, and more specifically to a defection detection component of the automated manufacturing.

### BACKGROUND

Automated manufacturing increases the productivity and consistency in the construction of processed articles. Articles made using multi-stage automated processes may be subjected to monitoring after particular stages to detect defects during manufacture. Monitoring is useful to prevent defective articles from being inadvertently sold to users, and to provide insights toward preventing defects during future manufacturing. Digital data may be used to assist in the detection of manufacturing defects during the manufacturing process. Digital image data can be analyzed to provide insights into visible defects of the processed article after manufacture, or between various stages of manufacture. Digital image analysis may be assisted by computers to improve speed and accuracy of detection within tolerances that may be difficult to ascertain without such assistance.

Current digital image analysis relies upon image data generated by cameras and computer-assisted analysis. However, current image analysis systems are difficult and expensive to adapt to emerging demands or new components or newly discovered defects. Additionally, current image analysis systems are expensive and require expertise to adapt or improve.

### SUMMARY

One aspect of this disclosure is directed to a manufacturing apparatus configured to produce a processed article, the manufacturing apparatus having a defect detection system. The defect detection system comprises a testing locus of the manufacturing apparatus staged at a known phase of manufacture of the processed article, a sensor mount in proximity of the testing locus, the sensor mount visually unobstructed to the testing locus, a camera coupled to the sensor mount and oriented toward the testing locus, the camera configured to generate image data, a processor in data communication with the camera, and a memory in data communication with the processor. The memory comprises a plurality of trained models, each of the trained models trained using a corpus of training images. Each of the training images depicting a processed article at the known phase of manufacture. Each of the models used to classify the image data into a plurality of categories, the categories comprising at least a defective presentation and a satisfactory presentation. The processor is operable to add to the training corpus the image data generated by the camera and retrain the associated models utilizing the updated training corpus. The processor is configured to generate a classification result for the processed article indicating whether the processed article comprises a detected defect based upon classification of the image data generated by the camera into one of the plurality of categories.

Another aspect of this disclosure is directed to a method for classifying the condition of a processed article during manufacture. The method comprises placing a processed article at a testing locus after a known stage of manufacture, the testing locus being in unobstructed visual proximity to a camera, and capturing image data with the camera, the image data depicting a visual condition of the processed article. The method further comprises transferring the image data to a processor in data communication with a memory storing a number of trained models, each of the trained models corresponding to one of a plurality of classifications for the processed article and trained using a corpus of associated training images, the classifications comprising at least a defective presentation and a satisfactory presentation. The method further comprises generating a classification label for the processed article based upon a correlation result between the image data and each of the trained models, the classification label aligning with the classification of the trained model in the corpus with which the image data most closely correlates. The method further comprises adding the image data to the corpus, and retraining the plurality of trained models by associating the image data with the trained model with which it most closely correlates.

A further aspect of this disclosure is directed to a non-transitory machine-readable storage medium having stored thereupon instructions that when executed by a processor cause the processor perform a method. The method of the instructions comprises placing a processed article at a testing locus after a known stage of manufacture, the testing locus being in unobstructed visual proximity to a camera, and capturing image data with the camera, the image data depicting a visual condition of the processed article. The method further comprises transferring the image data to a processor in data communication with a memory storing a number of trained models, each of the trained models corresponding to one of a plurality of classifications for the processed article and trained using a corpus of associated training images, the classifications comprising at least a defective presentation and a satisfactory presentation. The method further comprises generating a classification label for the processed article based upon a correlation result between the image data and each of the trained models, the classification label aligning with the classification of the trained model in the corpus with which the image data most closely correlates. The method further comprises adding the image data to the corpus, and retraining the plurality of trained models by associating the image data with the trained model with which it most closely correlates.

The above aspects of this disclosure and other aspects will be explained in greater detail below with reference to the attached drawings.

### BRIEF DESCRIPTION OF THE DRAWINGS

FIG. 1 is a diagrammatic view of a manufacturing system having a machine-learning fault detection component utilizing a camera.

FIG. 2 is a diagrammatic illustration of a training process completed by the processor of a defect detection system associated with a manufacturing system.

FIG. 3 is a flowchart illustration a method of defect detection by a defect detection system utilizing image data.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

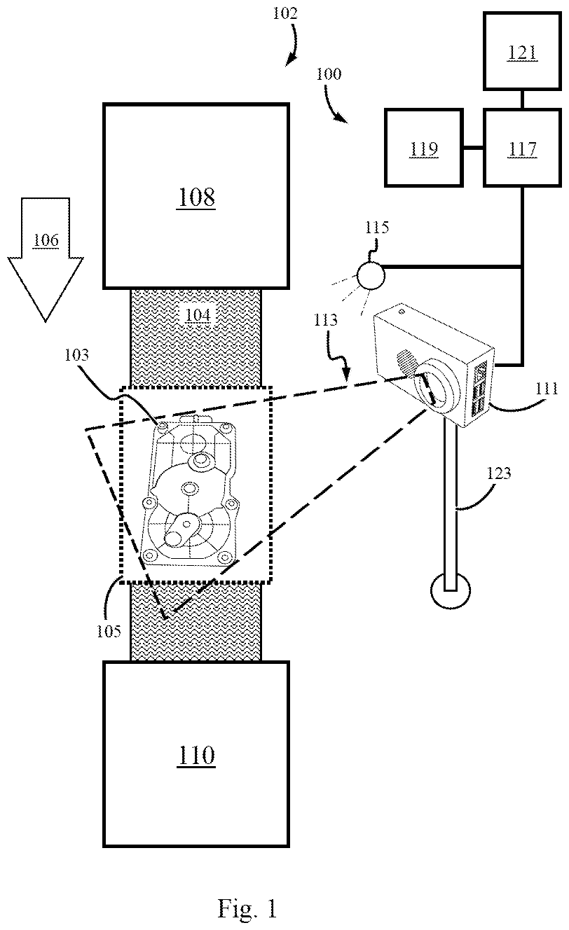

FIG. 1 is a diagrammatic illustration of a defect detection system 100 for use within a manufacturing environment 102 and having machine-learning capabilities. Defect detection system 100 is configured as part of a manufacturing process for a processed article 103. In the depicted manufacturing process, processed article 103 comprises an electrically-controlled motorized lever, but other embodiments can comprise other processed articles 103 without deviating from the teachings disclosed herein. The type of component, product, or article of manufacture comprising processed article 103 is effectively arbitrary, so long as defect detection system 100 can be trained to recognize the condition of processed article 103 with respect to at least one stage of manufacture. In the depicted embodiment, manufacturing environment 102 comprises of a multi-stage manufacturing system for producing processed article 103, but other embodiments may comprise other arrangements without deviating from the teachings disclosed herein.

In the depicted embodiment, manufacturing environment 102 comprises a testing locus 105 suitable for defect detection system 100 to perform automated inspections of processed article 103. As depicted, the testing locus 103 is a position on a conveyor 104 moving in a direction 106 between an antecedent phase machine 108 and a subsequent phase machine 110. In the depiction, antecedent phase machine 108 is a machine to perform an arbitrary phase of manufacture that results in a condition of processed article 103 suitable for detect detection, whereas subsequent phase machine 110 is a machine to perform an arbitrary subsequent phase of manufacture. Other embodiments may not comprise a subsequent phase machine 110 without deviating from the teachings disclosed herein. Although in the depicted embodiment processed article 103 is automatically delivered to and from testing locus 105 via conveyor 104, other embodiments may comprise a different arrangement without deviating from the teachings disclosed herein. By way of example, and not limitation, processed article 103 may be delivered to and/or from testing locus 105 manually, or in some combination of automatically, manually, or machine-controlled transport without deviating from the teachings disclosed herein.

For a duration of time while processed article 103 is at testing locus 105, the defect detection system 100 is configured to capture an image of processed article for image analysis. This image is captured by a camera 111 having a field of view 113 that includes at least a portion of processed article 103 at testing locus 105. In the depicted embodiment, the field of view 113 comprises the entirety of the outer surface of processed article 103, but in some embodiments camera 111 may be configured to focus the field of view 113 on some particular portion of processed article 103 without deviating from the teachings disclosed herein. In such embodiments, the limited field of view 113 may advantageously provide an enhanced imaging of a portion of processed article 103 that is especially prone to defects. In the depicted embodiment, camera 111 comprises a set of configurable features to make adjustments to the field of view 113 in accordance with a user specification. Advantageously, this configurability of camera 111 increases the usability the defect detection system 100 to accommodate a greater variety of processed articles 103 without requiring an entirely new defect detection system.

The conditions of testing locus 105 may be adjusted in order to optimize the imaging of camera 111 for use in defect detection. By way of example, and not limitation, defect detection system 100 comprises a light source 115 suitable to change the illumination conditions of testing locus 105. Adjusting the illumination conditions of testing locus 105 may advantageously improve the reliability of detection of certain defect conditions. In the depicted embodiment, light source 115 may comprise a multi-color light emitting diode (LED), but other embodiments may comprise other configurations without deviating from the teachings disclosed herein. In the depicted embodiment, light source 115 is in data communication with a processor 117, but other embodiments may comprise other configurations without deviating from the teachings disclosed herein. In the depicted embodiment, the output of light source 115 is configurable via instructions from processor 117, but other embodiments may comprise other arrangements without deviating from the teachings disclosed herein.

In the depicted embodiment, camera 111 is in data communication with the processor 117, and the operations of camera 111 may be controlled by processor 117. The actions of processor 117 may be controlled using a series of machine-operable instructions stored upon a storage medium. In the depicted embodiment, processor 117 is in data communication with a memory 119 storing thereupon instruction executable by processor 117.

Processor 117 may be embodied as a mobile processing device, a smartphone, a tablet computer, a laptop computer, a wearable computing device, a desktop computer, a personal digital assistant (PDA) device, a handheld processor device, a specialized processor device, a system of processors distributed across a network, a system of processors configured in wired or wireless communication, or any other alternative embodiment known to one of ordinary skill in the art. Memory 119 may be embodied as a non-transitory computer-readable storage medium or a machine-readable medium for carrying or having computer-executable instructions or data structures stored thereon. Such non-transitory computer-readable storage media or machine-readable medium may be any available media embodied in a hardware or physical form that can be accessed by a general purpose or special purpose computer. By way of example, and not limitation, such non-transitory computer-readable storage media or machine-readable medium may comprise random-access memory (RAM), read-only memory (ROM), electrically erasable programmable read-only memory (EEPROM), optical disc storage, magnetic disk storage, linear magnetic data storage, magnetic storage devices, flash memory, or any other medium which can be used to carry or store desired program code means in the form of computer-executable instructions or data structures. Combinations of the above should also be included within the scope of the non-transitory computer-readable storage media or machine-readable medium. Computer-executable data may include instructions and other data which cause a general purpose computer, special purpose computer, or special purpose processing device to perform a certain function or group of functions. Computer-executable data may also include program modules that are executed by computers in stand-alone or network environments. Program modules may include routines, programs, objects, components, or data structures that perform particular tasks or implement particular abstract data types. Computer-executable data, associated data structures, and program modules represent examples of the program code means for executing steps of the methods disclosed herein. The particular sequence of such executable instructions or associated data structures represents examples of corresponding acts for implementing the functions described in such steps.

Processor 117 is additionally in data communication with a human-machine interface (HMI) 121. HMI 121 is configured to provide a user input to the processor 117 and output from processor 117. HMI 121 may comprise a keyboard, mouse, and display configuration, or may comprise other configurations such as a touchscreen display, haptic input and output, audible or speech interface, augmented reality display, virtual reality headset, or any other user interface without deviating from the teachings disclosed herein.

In the depicted embodiment, camera 111 is placed with respect to the defect detection system 100 using a sensor mount 123. In the depicted embodiment, sensor mount 123 is a camera mount 123 comprising a boom-style independent mount, but other embodiments may utilize other configurations of a sensor mount without deviating from the teachings disclosed herein. In the depicted embodiment, camera mount 123 places camera 111 between the antecedent phase machine 108 and the subsequent phase machine 110, but other embodiments may comprise additional or different placements with respect to the manufacturing stages of processed article 103 without deviating from the teachings disclosed herein. In some embodiments, defect detection system 100 may comprise a plurality of cameras 111 utilized at different phases of the manufacturing process of processed article 103.

In some embodiments, a single camera 111 may have an adjustable position or orientation such that field of view 113 is adjusted with respect to the defect detection system 100. In such embodiments, the camera 111 may be adjustably positioned as processed article 103 moves to different testing loci 105 (not shown) at different stages of manufacture. By way of example, and not limitation, camera 111 may be adjusted to “track” processed article 103 as it moves past subsequent phase machine 110 to a second testing locus 105. In such an arrangement, camera 111 may be utilized to generate image data depicting processed article after subsequent phase machine 110. In such an embodiment, subsequent phase machine 110 effectively acts as the antecedent phase machine 108 in relation to a later testing locus 105 (not shown).

Additional features and functions of camera 111 may be advantageous in the identification of visual defects of the processed article 103. In conventional systems, the image resolution of a camera or other optical sensor can limit the detection of certain types of defects, such as metal corrosion, pitting, or other flaws or defects in material used during manufacture having a small visible area. In contrast, camera 111 comprises a resolution sufficient that a single pixel may correspond to the size of such small detects in the manufacture and provide sufficient imaging resolution that such defects are detectable by processor 117 during analysis of the image data generated by camera 111. In some such embodiments, the resolution of camera 111 may conform to a 320p resolution standard or better, though other embodiments may exhibit other configurations without deviating from the teachings disclosed herein. In conventional systems, the image data may be presented as monochromatic data, whereas camera 111 comprises a full-color optical sensor. A full-color optical sensor is advantageously capable of generating image data that distinguishes pixels by hue, saturation, and brightness, whereas monochromatic images are generally only represented by differences in brightness. Two adjacent pixels may exhibit similar brightness, but differences in hue, saturation, or both. Such pixels would not be detectable using a conventional monochromatic sensor, but are capable of detection using camera 111 of the defect detection system 100. Additionally, the coordination of camera 111 with light source 115 can be utilized to optimize conditions for defect detection. By way of example, and not limitation, light source 115 may be configured to emit colored light of a particular hue that maximizes the visibility of certain types of corrosion. In an additional example, certain types of defects may be more easily observed visually in lighting having a particular brightness or directional behavior (i.e., casting particular shadow patterns). In this fashion, the configurability of light source 115 provides an advantageous improvement over conventional detection systems.

Another advantage of the depicted defect detection system 100 over conventional systems is that processor 117 can utilize machine learning techniques to rapidly train and re-train for defect detection of processed articles 103. By way of example, and not limitation, memory 119 comprises a corpus of training data comprising one or more sets of training images. Each of the sets of training images comprises a corpus of example images, each example image depicting a processed article 103 having a known state of defect that matches the known state of defect associated with that corpus. In the depicted embodiment, the corpus of training data may comprise an arbitrary number of defects provided that each of the defects has associated therewith a known defect of processed article 103. This process advantageously reduces the complexity of initially configuring or updating the defect detection system 100 compared to other conventional systems. In conventional systems, an expert user would necessarily need to provide code to instruct the system in how to detect defects using image data. Thus, the expert user would necessarily need to understand how to recognize the defects visually, as well as how to program, compile, and implement the code necessary In contrast, defect detection system 100 advantageously permits a user having no coding experience to prepare the system for detection by instead merely having a body of example images of defects to train the system. Images can be arbitrarily added or removed from the corpus of training data, and new models can be built rapidly to respond to emergent needs of the manufacturing process in a timely fashion. In some embodiments, a user may provide additional images pertaining to a newly defined defect via HI 121.

HMI 121 may additionally provide output to the user indicating a status or other condition of processed article 103 in real-time. By way of example, and not limitation, HMI 121 may present a warning to a user via a display indicating that processed article 103 exhibits a known defect. In response, the user may advantageously remove processed article 103 from the manufacturing process for purposes of quality control. For example, the user may remove the defective article from the manufacturing operation to prevent the defective article from being provided to customers, as well as to provide the defective article to the user for examination of the defects and seeking a solution for future manufacture of such processed articles. In some embodiments, processor 117 may create a log of instances of detected defects for later review. In such embodiments, the log may be stored in memory 119 or another suitable memory without deviating from the teachings disclosed herein. In some embodiments, processor 117 may deliver the results of the inspection of processed article 103 to a different processor (not shown) for further review or quality control purposes. In such embodiments, processor 117 and the different process are in data communication, which may be achieved using a wired or wireless data connection (not shown). Other embodiments may comprise other arrangements without deviating from the teachings disclosed herein.

In practice, defect detection system 100 may also exhibit continued learning operations. Upon use of the models by processor 117 to categorize image data generated by camera 111, the image data may be added to a training corpus within memory 119 that is associated with the categorized condition determined from the image data. This process expands and updates the training corpuses as additional processed articles 103 are assessed for defects. Over time, this continual expansion and refinement of the data available for training can be utilized to recreate an improved model for defect detection system 100.

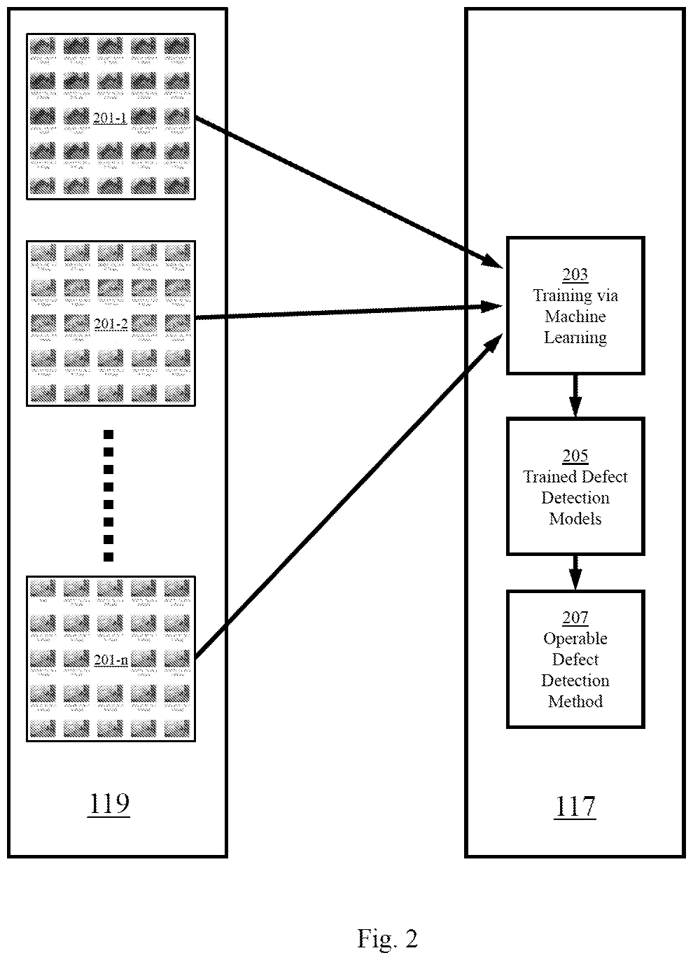

FIG. 2 is a diagrammatic illustration of the process completed by processor 117 to prepare one or more detection models for use in the defect detection operation thereof. Within memory 119, are an arbitrary number of corpuses 201, each corpus 201 comprised of a number of images depicting a processed article 103 (see FIG. 1) categorized as having a known condition at a particular phase of manufacture. The number of images presented in each of the corpuses 201 is arbitrary, but in the depicted embodiment a minimum number of images is required to properly train a detection model. The number of distinct corpuses 201 is additionally arbitrary, and conforms to a number of known categories of defects to be detected by the defect detection system. In the depicted embodiment, corpus 201-1 corresponds to a first categorization of defect having a first presentation of a processed article in a first condition, corpus 201-2 corresponds to a second categorization having a second presentation of a processed article in a second condition, and so on until corpus 201-n corresponds to an arbitrary n^{th} categorization of an n^{th} presentation of a processed article in an associated n^{th} condition. Some embodiments may comprise a different arrangement having a different number of corpuses 201 without deviating from the teachings disclosed herein. In some embodiments, an image presenting a processed article depicting two or more simultaneous conditions may be allocated to a distinct corpus 201 having a separate categorization for such presentations that comprise such simultaneous conditions, rather than allocated to multiple ones of corpuses 201 simultaneously.

In the depicted embodiment, one of corpuses 201 may correspond to a presentation of a processed article without any visual defect (categorized as “satisfactory”), whereas the remaining n−1 ones of corpuses 201 correspond to presentations of the processed article comprising at least one visual defect.

However, in some embodiments, all of corpuses 201 may comprise images depicting some form of categorized visual defect. In such embodiments, a failure to classify image data from camera 111 (see FIG. 1) could be considered to indicate no detected defect without deviating from the teachings disclosed herein.

The corpuses 201 are provided from memory 119 to processor 117 to be utilized in a training process 203. Training process 203 utilizes machine learning to characterize and identify the distinct characteristics of the image data unique to each of corpuses 201 in a training sub-routine 203 and create associated trained models 205. The models may be stored in an instantaneous or random-access partition of system memory (not) shown accessible to processor 117, or may be stored in an additional storage, such as a distinct partition of memory 119. Processor 117 then provides those trained defect detection models 205 during the operable subroutines executed during the defect detection method 207 that performs the core functions of defect detection system 100 (see FIG. 1).

Updating of the trained models 205 may be initiated at any time, and the system may generate new models 205 for use in response to updates to the corpuses 201. Advantageously, the corpuses 201 may be updated with image data obtained during the operation of the defect detection method 207 to provide an expanding training corpus of images used in real-world conditions.

Similarly, new corpuses 201 corresponding to a new identifiable defect may be implemented at any time simply by providing a set of training images presenting the identifiable defect. In some such embodiments, new corpuses 201 may be generated in response to so-called “combination” conditions, wherein the processed article exhibits a plurality of visually-identifiable defects. When the set of corpuses 201 is provided, a new training may be completed by the training process 203 to generate new and updated trained models 205 for use in the defect detection method 207.

In the depicted embodiment, a user may selectively choose a subset of corpuses 201 to be utilized in training, rather than the entire set of corpuses 201. The ability for a user to update the trained models 205 utilized by the defect detection system 100 advantageously permits the user to successfully operate the system with a variety of processed articles merely by updating which corpuses 201 are used to generate the active trained models 205. By way of example, and not limitation, similar but distinct processed articles 103 (see FIG. 1) may be manufactured using the same manufacturing process but each processed article may be built to different specification. Thus, in some variants of processed article 103, a particular exhibited trait may be considered a defect, whereas that same trait would be considered satisfactory in a different variant. Selective re-training of the trained models 205 advantageously permits a greater degree of adaptability of the defect detection system 100 because the system may be effectively utilized on a greater variety of processed articles conforming to a greater variety of specifications. Additionally, the re-training of the trained models 205 may be accomplished without requiring a user to be able to perform complex reprogramming. Instead, a user need only be able to identify which of corpuses 201 should be included and utilized in the training of the models 205.

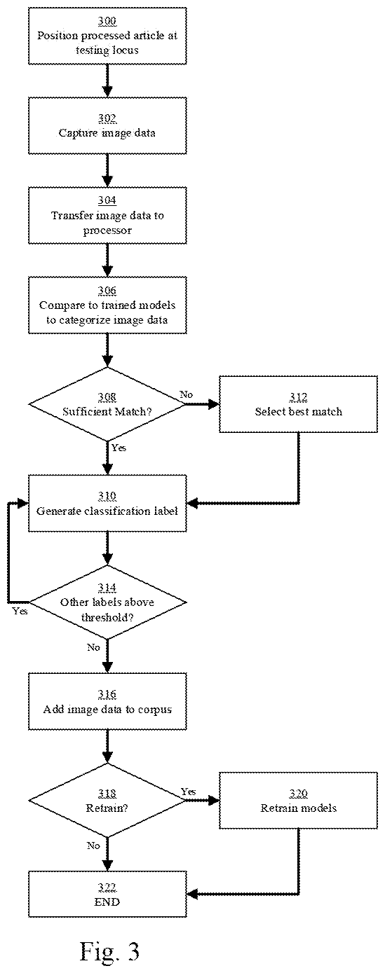

FIG. 3 is a flowchart illustrating the defect detection method of a defect detection system, such as defect detection system 100 (see FIG. 1). The method begins at step 300, when a processed article is positioned at a testing locus after a stage of manufacture. When the article of manufacture is placed at the testing locus, the method proceeds to step 302, where image data of the article of manufacture is captured by a sensor, such as a camera. After capture, the image data is transferred to a processor at step 304. After acquisition, the processor compares the image data to trained models of categorized conditions of the processed article at step 306. If the image data sufficiently matches one of the trained models at step 308, the method generates a classification label at step 310 to be assigned to the image data. The classification label is associated with a presentation of a known condition of the processed article, including at least a known first defective condition. In some embodiments, the valid classification labels include a satisfactory condition and an additional arbitrary number of additional known defective conditions.

If none of the trained models match with the image data beyond a threshold value, the method may instead proceed to step 312, where the processor assigns the best match of the available matches before generating the classification label at step 310. In some embodiment, step 312 may not exist, and if none of the categorizations are considered sufficiently applicable, the method may instead proceed to a fail state or additional status (not shown) without deviating from the teachings disclosed herein.

After generation of the classification label and association of the label with the image data, the method proceeds to step 314, where additional checks are made if other labels are appropriate because their respective models match the image data above the threshold value. If so, these additional labels may be assigned to the image data at step 310, and the labels may be iteratively checked between steps 310 and 314 until no additional labels are found to be appropriate. Some embodiments may not comprise a step 314 without deviating from the teachings disclosed herein.

In the depicted embodiment, after generation of all applicable classification labels to the image data, the method proceeds to step 316, where the image data is added to the corpus of training data. Some embodiments may not comprise step 316 without deviating from the teachings disclosed herein. When providing the image data to the corpus, the image data is only included with subsets of the corpus that fit the classification label assigned to the image data.

After adding the image data to the corpus, the system checks at step 318 if a retraining of the models is desired. If the user indicates that the models should be retrained, the method proceeds to step 320 where the models are retrained using the updated corpus from step 316. Otherwise, the method ends at step 322. In the depicted embodiment, the final step 322 additionally comprises producing a report of classification label or labels associated with the article of manufacture, which may be presented to a user via a human-machine interface (such as HMI 121; see FIG. 1), recorded in a log file, or transmitted to an additional processor. Some embodiments may complete the method by performing a combination of these actions without deviating from the teachings disclosed herein. Some embodiments may not comprise one or more of steps 316-320 without deviating from the teachings disclosed herein.

After step 322, the system may return to step 300 to perform the method again for a subsequent processed article. In this manner, the method may be performed consecutively for each processed article being produced during the manufacturing process. In some such embodiments, the return of the method to step 300 may be controlled manually by a user without deviating from the teachings disclosed herein.

The method of the system may be iteratively utilized at different stages of manufacture to accommodate for defects that may be introduced at each of the different stages. In such embodiments, the system utilizing the method comprises at least an equivalent number of testing loci to accommodate the detections after each of the desired stages of manufacture. In such embodiments, the system may additionally comprise a different image sensor for step 304 positioned respectively according to the associated testing locus. In these multiple detection embodiments, the corpus may comprise a plurality of subsections, each of the subsections comprising a subset of the corpus that is suitable for testing for defects after the particular stage of manufacture.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A manufacturing apparatus configured to produce a processed article, the manufacturing apparatus having a defect detection system comprising:
a testing locus of the manufacturing apparatus staged at a known phase of manufacture of the processed article;
a sensor mount in proximity of the testing locus, the sensor mount visually unobstructed to the testing locus;
a camera coupled to the sensor mount and oriented toward the testing locus, the camera configured to generate image data;
a processor in data communication with the camera; and
a memory in data communication with the processor,
wherein
the memory comprises a plurality of trained models, each of the trained models trained using a corpus of training images, each of the training images depicting a processed article at the known phase of manufacture, each of the models used to classify the image data into a plurality of categories, the categories comprising at least a defective presentation and a satisfactory presentation,
wherein the processor is operable to add to the training corpus the image data generated by the camera and retrain the associated models utilizing the updated training corpus, and
wherein the processor is configured to generate a classification result for the processed article indicating whether the processed article comprises a detected defect based upon classification of the image data generated by the camera into one of the plurality of categories.

2. The manufacturing apparatus of claim 1, further comprising a human-machine interface, and wherein the memory is configured to permit a user to update the training corpus and retrain the plurality of trained models via the human-machine interface.

3. The manufacturing apparatus of claim 1, wherein the plurality of categories comprise at least a first defective presentation correlated to a first defective condition of the processed article, a second defective presentation corresponding to a second defective condition of the processed article, and a satisfactory presentation corresponding to a condition of the processed article that does not comprise a visually-detectable defect.

4. The manufacturing apparatus of claim 1, wherein the processor delivers the classification result to a second processor associated with the manufacturing apparatus.

5. The manufacturing apparatus of claim 1, wherein the processor is further operable to detect flaws of the processed article presented in the image data generated by the camera that are visually represented in the image data in an area of 1×1 square pixels or larger.

6. The manufacturing apparatus of claim 1, wherein the camera comprises a color camera and the image data generated by the camera comprises color data.

7. The manufacturing apparatus of claim 1, wherein the camera is assembled using an additive manufacturing technique.

8. The manufacturing apparatus of claim 1, wherein the image data resolution conforms to at least a 320p video standard.

9. A method for classifying the condition of a processed article during manufacture, the method comprising:
placing a processed article at a testing locus after a known stage of manufacture, the testing locus being in unobstructed visual proximity to a camera;
capturing image data with the camera, the image data depicting a visual condition of the processed article;
transferring the image data to a processor in data communication with a memory storing a number of trained models, each of the trained models corresponding to one of a plurality of classifications for the processed article and trained using a corpus of associated training images, the classifications comprising at least a defective presentation and a satisfactory presentation;
generating a classification label for the processed article based upon a correlation result between the image data and each of the trained models, the classification label aligning with the classification of the trained model in the corpus with which the image data most closely correlates;
adding the image data to the corpus; and
retraining the plurality of trained models by associating the image data with the trained model with which it most closely correlates.

10. The method of claim 9, wherein the defective presentation classification is a first defective presentation, and wherein the classifications comprise at least the first defective presentation, a second defective presentation, and the satisfactory presentation.

11. The method of claim 9, wherein the correlation between the image data and each of the trained models is performed by correlating the images in corresponding 1×1 square pixel areas of the respective images.

12. The method of claim 9, wherein the image data comprises a color image.

13. The method of claim 9, wherein the image data resolution conforms to at least a 320p video standard.

14. The method of claim 9, further comprising generating a second classification result for the processed article when the correlation of the image data with a trained model other than the most-closely correlated comprises a correlation value above a threshold value.

15. The method of claim 14, further comprising generating additional classification results for the processed article for each correlation of the image data with a trained model that comprises a correlation value above the threshold value.

16. The method of claim 9, further comprising:
placing the processed article at a second testing locus after a second known stage of manufacture, the second testing locus being in unobstructed visual proximity to a camera;
generating second image data with the camera, the second image data depicting a visual condition of the processed article;
transferring the second image data to the processor in data communication with a memory storing a second number of trained models, each of the second trained models corresponding to one of a plurality of classifications for the processed article and trained using a corpus of associated training images, the classifications comprising at least a second defective presentation and a satisfactory presentation; and
generating a second classification label for the processed article based upon a correlation result between the second image data and each of the second trained models within the corpus, the classification label aligning with the classification of the second trained model in the corpus with which the second image data most closely correlates.

17. The method of claim 16, further comprising generating a third classification result for the processed article when the correlation of the second image data with a trained model other than the most-closely correlated comprises a correlation value above a threshold value.

18. The method of claim 17, further comprising generating additional classification results for the processed article for each correlation of the second image data with a trained model that comprises a correlation value above the threshold value.

19. A non-transitory computer-readable medium having stored thereon instructions that, when executed by a processor, cause the processor to perform the steps of:
advancing a processed article to a testing locus after a known stage of manufacture via a conveyor controlled by the processor, the testing locus being in unobstructed visual proximity to a camera;
capturing image data with the camera, the image data depicting a visual condition of the processed article;
comparing the image data to a number of trained models, each of the trained models corresponding to one of a plurality of classifications for the processed article and trained using a corpus of associated training images, the classifications comprising at least a defective presentation and a satisfactory presentation;
generating a classification label for the processed article based upon a correlation result between the image data and each of the trained models, the classification label aligning with the classification of the trained model in the corpus with which the image data most closely correlates;
adding the image data to the corpus; and
retraining the plurality of trained models by associating the image data with the trained model with which it most closely correlates.

20. The non-transitory computer-readable medium of claim 19, further storing instructions thereon that, when executed by a processor, cause the processor to perform additional steps comprising:
advancing the processed article at a second testing locus after a second known stage of manufacture via the conveyor, the second testing locus being in unobstructed visual proximity to a camera;
generating second image data with the camera, the second image data depicting a visual condition of the processed article;
transferring the second image data to the processor in data communication with a memory storing a second number of trained models, each of the second trained models corresponding to one of a plurality of classifications for the processed article and trained using a corpus of associated training images, the classifications comprising at least a second defective presentation and a satisfactory presentation; and
generating a second classification label for the processed article based upon a con-elation result between the second image data and each of the second trained models within the corpus, the classification label aligning with the classification of the second trained model in the corpus with which the second image data most closely correlates.
